(19) United States
(12) Patent Application Publication
(10) Pub. No.: US 2006/0285521 A1
(43) Pub. Date: Dec. 21, 2006

(54) Method, system, apparatus and software product implementing downlink code management for fractional dedicated physical channel in timing conflict situations

(76) Inventor: Ville Steudle, Turku (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/416,798

(22) Filed: May 2, 2006

Related U.S. Application Data
(60) Provisional application No. 60/677,092, filed on May 2, 2005.

(51) Int. Cl. H04Q 7/00; H04B 7/216

(52) U.S. Cl. 370/331; 370/335; 370/342

(57) ABSTRACT

A method, apparatus, system, network element and and software product are presented for enabling a user equipment to efficiently use downlink codes during soft handover. The user equipment receives radio links in parallel from different base stations. In a code-optimized version, the code of at least one of the radio links is shared with at least one other user terminal during the soft handover. However, exclusive codes are employed for the other radio links to the user equipment. In a network-management-optimized version, exclusive codes are employed for all radio links to the user equipment. In this way, drifting radio links during soft handover can be kept within the receiver window of the user equipment.

### CROSS-REFERENCE TO RELATED APPLICATION

Priority is claimed to U.S. Provisional Application 60/677,092 filed May 2, 2005.

### FIELD OF INVENTION

The present invention relates generally to wireless telcommunication, and more particularly to optimization of downlink code usage.

### BACKGROUND OF INVENTION

The Third Generation Partnership Project (3GPP) Release-6 has introduced a new feature for optimization of downlink code usage called Fractional Dedicated Physical Channel (F-DPCH). With this scheme, multiple user equipments (UEs) time-share a single downlink code. The present invention solves a problem that arises with F-DPCH together with soft handover (i.e. multiple parallel radio links).

Code sharing (time multiplex) with F-DPCH leads to problems with timing adjustments in soft handover. In a soft handover state, there are multiple, only loosely synchronized radio links, which can drift independently of each other especially when the UE moves. So-called “downlink timing re-adjustments” are performed when one of the links starts to drift out of the receiver's reception window.

Unlike the case where all UEs have their own DPCH channel with no timing dependencies to other UEs, with F-DPCH, the timing of the different UEs can conflict, which presents a problem that has to be solved. Here, the timing of one particular UE cannot be shifted forward or backward in time, as the adjacent positions within the frame can be occupied by other UEs, sharing the same code.

The present invention is aimed at finding a way to distribute the UEs to different codes (called here “exclusive codes”) whenever needed (i.e. in soft handover, when the network does not know the UE's timing reference cell any more). Because F-DPCH is a new feature, there is no prior solution for the soft handover (SHO) issue.

### SUMMARY OF INVENTION

This invention presents a solution for performing code assignments in SHO. The main idea of the F-DPCH is to time multiplex multiple users onto a single channelisation code. The F-DPCH transmissions to different UEs can be placed back-to-back on this code.

The method of the present invention calls for a user equipment to use downlink codes during soft handover, in the following way. The user equipment receives radio links in parallel from different base stations. During the soft handover, code of one or more of the radio links is shared with at least one other user terminal. And, exclusive codes are employed for more of the radio links, while the exclusive codes are not shared with any other user terminal.

### BRIEF DESCRIPTION OF THE DRAWINGS

FIG. 1 shows the principle of F-DPCH in a simplified diagram.

FIG. 2 describes an example of reconfigurations for a UE on a trajectory through three different cells.

FIG. 3 shows code tree consumption for F-DPCH with or without SHO.

FIG. 4 shows a method according to an embodiment of the present invention.

FIG. 5 shows user equipment according to an embodiment of the present invention.

FIG. 6 shows a system according to an embodiment of the present invention.

FIG. 7 shows a network element according to an embodiment of the present invention.

### DETAILED DESCRIPTION OF AN EMBODIMENT OF THE INVENTION

3GPP networks use soft handover (SHO) to improve their coverage and cell edge performance. In SHO, multiple radio links from different base stations are received in parallel in the UE. As the combining logic in the UE is of limited complexity, all radio links have to fall within a common UE reception window of plus or minus 148 chips. If one of the radio links drifts out of the reception window (e.g. as the UE is moving), the UE asks the network to adjust the transmission timing with a step of plus or minus 256 chips.

For the combination of F-DPCH with soft handover, this has the following consequences. First, no radio link timing adjustments are possible for a single UE, as the adjacent downlink transmission time instants are blocked by other UEs on the same shared code. Second, because no adjustments are possible, transmissions of shared F-DPCH from different cells to a single UE cannot be adjusted to fit within the UEs +/−148 chip reception window. And third, the radio link would need to be dropped, which can lead to a connection failure (dropped call).

A solution to these problems is to use exclusive F-DPCH codes for the majority of radio links (radio links 2 to n), i.e. to use the same slot format as with shared codes, but not to share these codes with other UEs, but instead map one single UE per code. According to this solution, radio link timing adjustments are possible in the same way as for DPCH. Also, drifting radio links during SHO can be kept within the receiver window. Furthermore, UE receiver complexity is kept simple (no window extension, same slot format can be used)

As the first radio link (radio link 1) remains the timing reference and is not adjusted, its code can be shared also during SHO. If at a later point, this particular radio link is removed, then, according to the current 3GPP specifications, the timing reference becomes unknown to the network until the UE exits the SHO state, having once again only one single link.

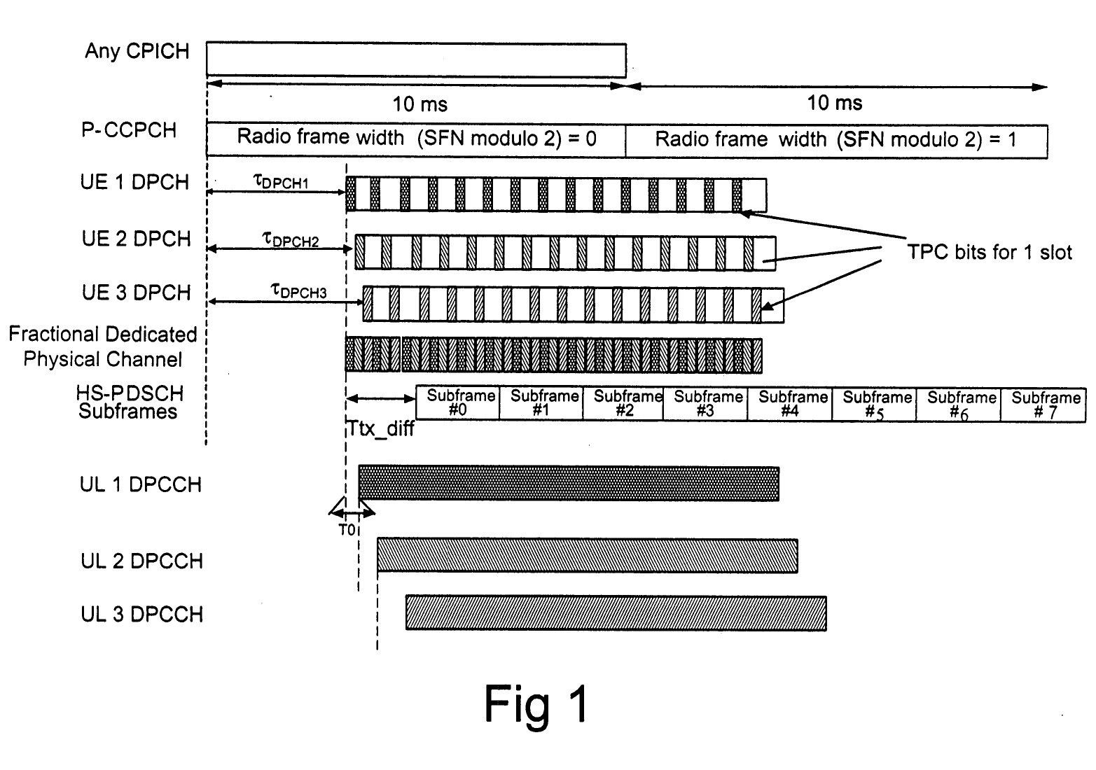

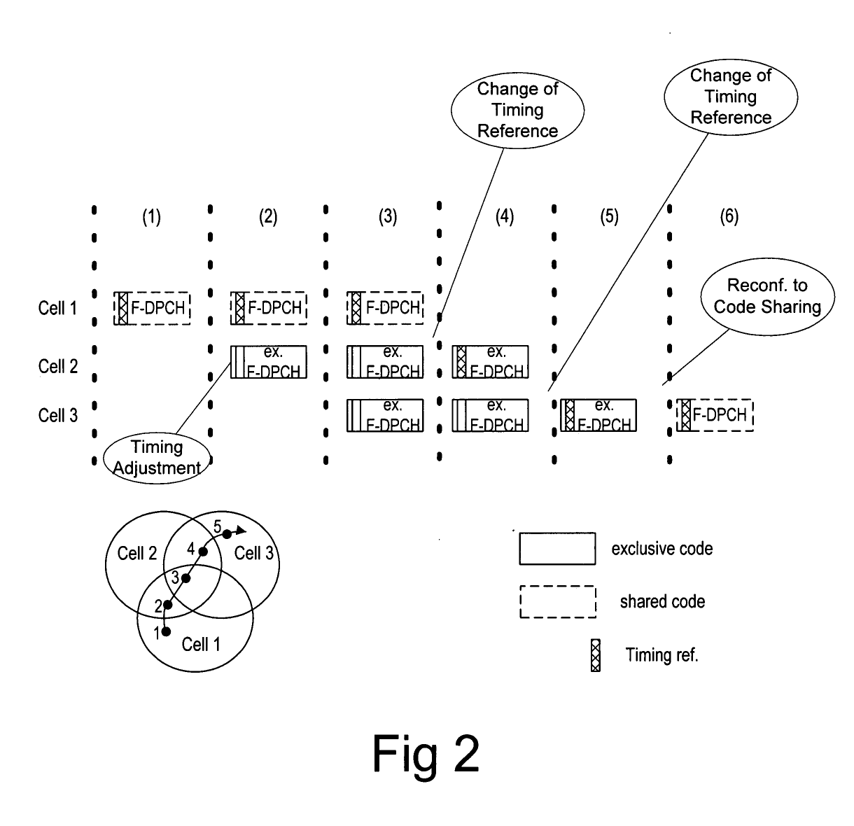

FIG. 1 illustrates the environment in which the present invention operates. A person skilled in the art will understand that the principle of FIG. 1 is that downlink transmissions are interleaved to different UEs onto one single code. FIG. 2 provides an example of F-DPCH SHO operation is shown, with a UE moving through 3 cells.

If, in the future, the signalling is updated to allow the network to know the cell used by the UE as timing reference also after the initial radio link is removed, then the code for that reference cell could be shared in SHO, similar to the first radio link. That is, as long as the radio link used as a timing reference by the UE is known to the network, the code of that particular radio link can be shared with other UEs. A UE does not need downlink timing adjustments for the timing reference link, because that one's timing remains constant.

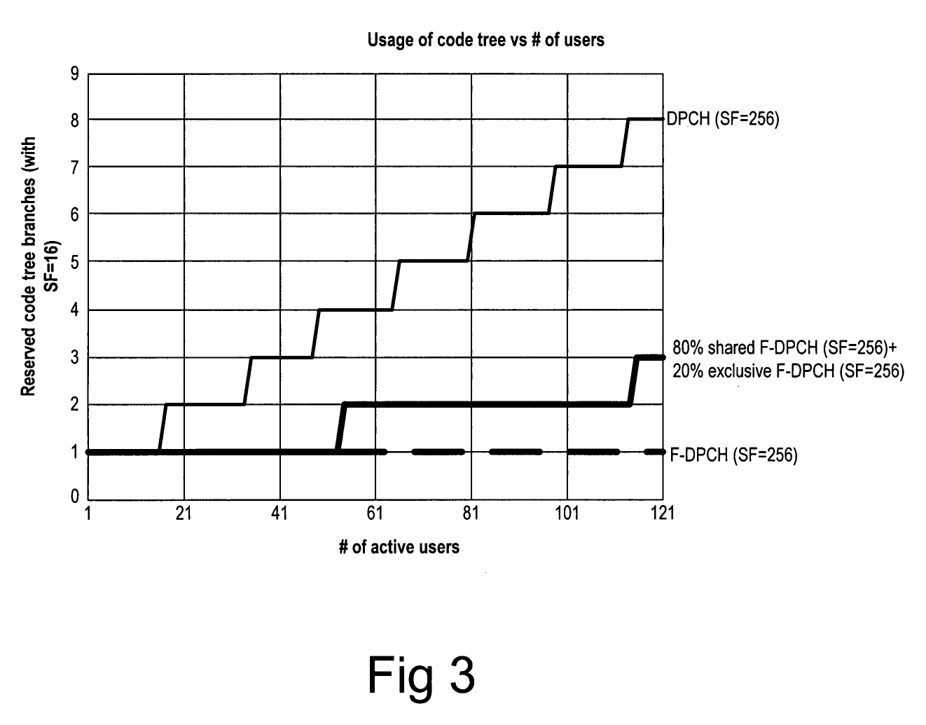

Although the SHO operation causes some penalty for the code saving performance, the code saving when using F-DPCH is still very significant even if SHO is assumed, as shown in FIG. 3. The different curves in FIG. 3 represent: DPCH, “pure” F-DPCH (100% of the UEs on shared codes), and F-DPCH with 20% of the users using “exclusive codes.” Note that the total number of UEs in SHO is larger than 20%, as some UEs have this cell as their timing reference and therefore can share the code.

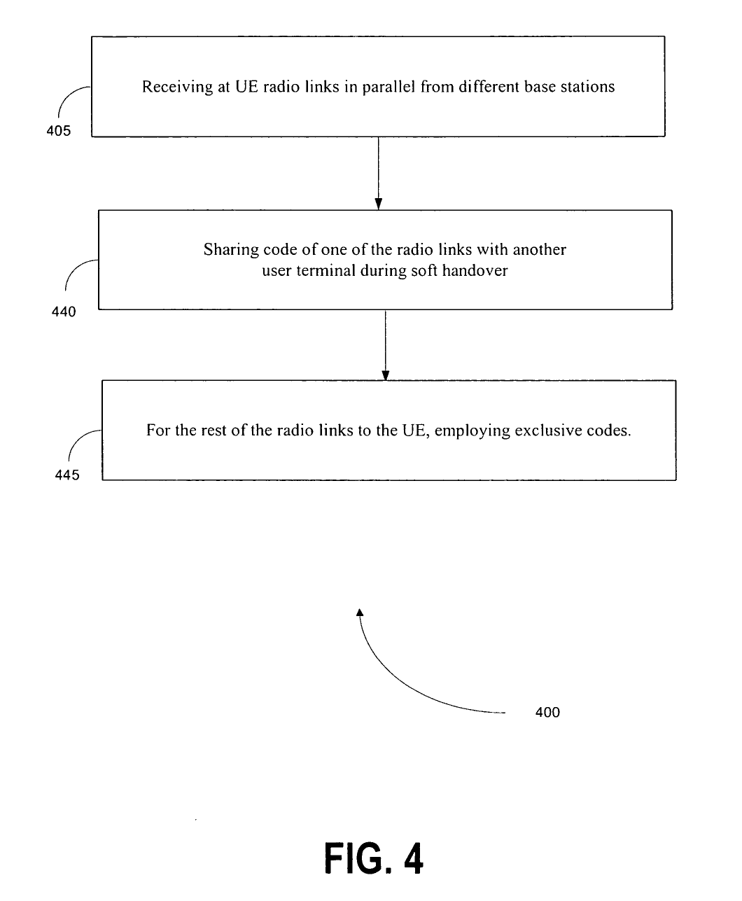

Referring now to FIG. 4, a method 400 is shown according to an embodiment of the present invention. A user equipment (UE) receives 405 radio links in parallel from different base stations. Then, code of one of the radio links is shared 440 with another user terminal during soft handover. And, for the rest of the radio links to the UE, exclusive codes are employed 445.

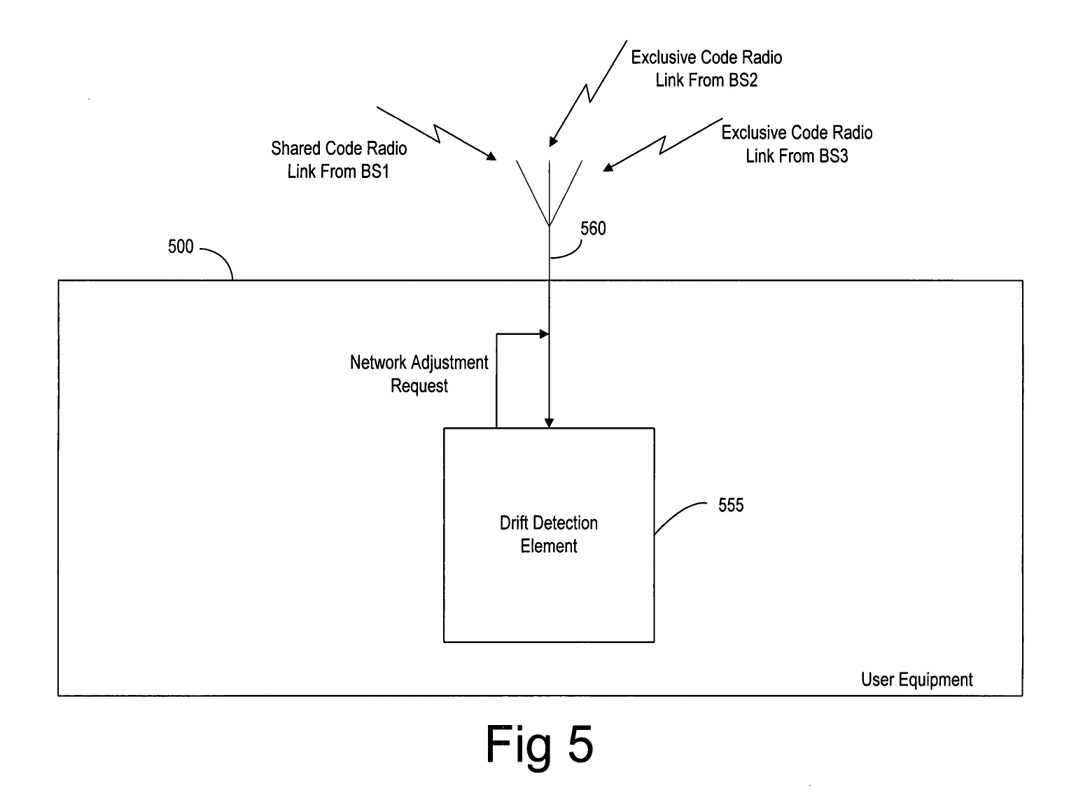

Turning now to FIG. 5, user equipment 500 is for using downlink codes during soft handover. A transceiver 560 is configured to receive radio links in parallel from different base stations. A drift detection element 555 is responsive to one of the radio links drifting out of a reception window, and is configured to request a network adjustment in order to prevent or compensate for the drift. Furthermore, in this embodiment, code of at least one of the radio links is available to be shared with at least one other user terminal, during the soft handover. The exclusive codes are employed by radio links other those radio links for which code is available to be shared, the exclusive codes not being shared with any other user terminal.

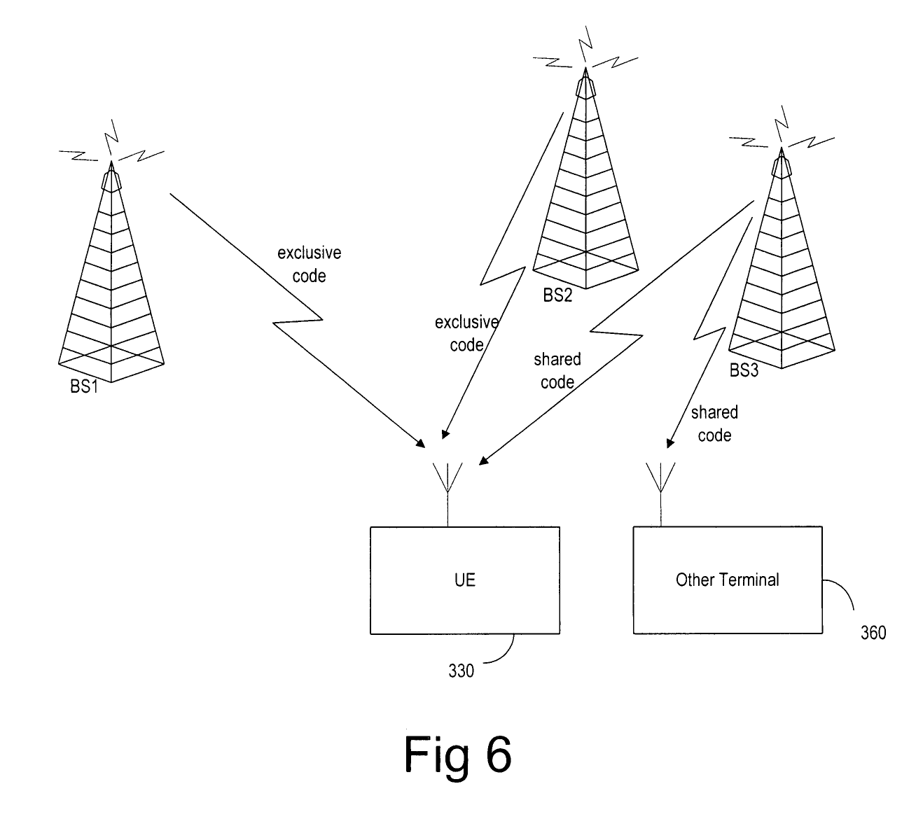

FIG. 6 illustrates a system according to an embodiment of the present invention, including a plurality of base stations BS1, BS2, and BS3. User equipment 330 is for receiving radio links in parallel from the base stations during a soft handover. Other user terminals 360 are for sharing code of a radio link with the user equipment, during the soft handover. Exclusive codes are employed by the user equipment 330 without sharing the exclusive codes with other user terminals.

It should be noted that, although in this embodiment the “code can be shared,” this does not exclude an alternative embodiment of not sharing the code (and using an exclusive code for that radio link as well). Not sharing the code means some penalty concerning the code usage, but simplifies signalling and radio resource control algorithms. Thus, in FIG. 6, it is alternatively possible that the “shared code” from BS3 to user equipment 330 is instead an exclusive code.

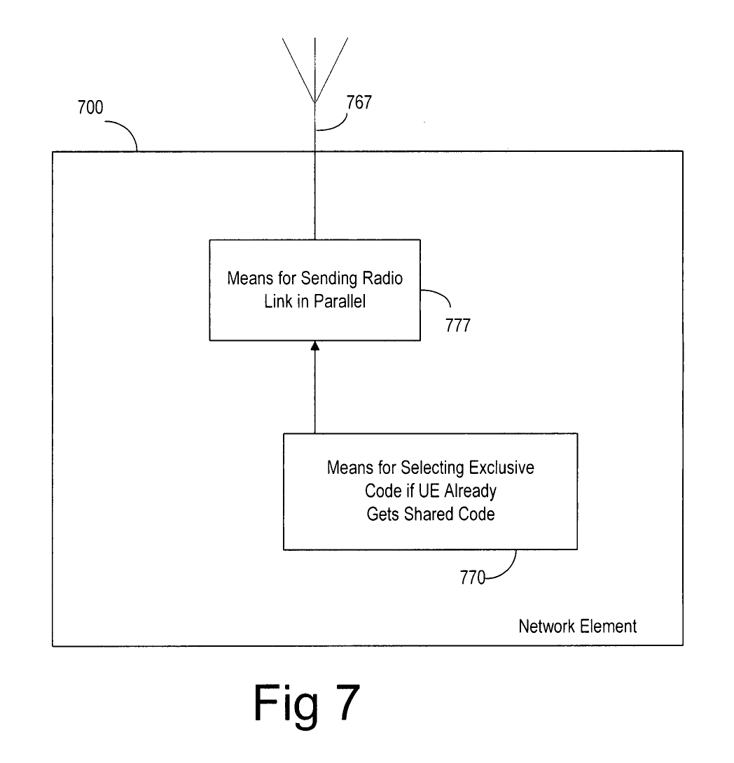

Turning now to FIG. 7, this illustrates a network element 700 according to an embodiment of the present invention. The network element includes means such as a sender module 777 for sending to a user equipment a radio link in parallel with other radio links from different base stations or sectors. The network element 700 also includes means such as a selctor 770 which employs an exclusive code for the radio link if one of the other radio links employs a shared code that is shared with at least one other user terminal.

It should be borne in mind that, although keeping one or more radio links shared even in SHO optimizes the code savings, it is not a requirement for the operation of F-DPCH in SHO. Another alternative is to use exclusive codes for all radio links. That way, some code saving gains would be sacrificed for the purpose of network management algorithm simplicity.

The embodiments described above can be implemented using a general purpose or specific-use computer system, with standard operating system software conforming to the method described herein. The software is designed to drive the operation of the particular hardware of the system, and will be compatible with other system components and I/O controllers. The computer system of this embodiment includes a processor 770 shown in FIG. 7 which serves as a means for selecting exclusive code if the UE already gets shared code, and this processor consists of a single processing unit, or multiple processing units capable of parallel operation, or the CPU can be distributed across one or more processing units in one or more locations, e.g., on a client and server. An accompanying memory may comprise any known type of data storage and/or transmission media, including magnetic media, optical media, random access memory (RAM), read-only memory (ROM), a data cache, a data object, etc. Moreover, similar to CPU 770, the memory may reside at a single physical location, comprising one or more types of data storage, or be distributed across a plurality of physical systems in various forms.

It is to be understood that the present figures, and the accompanying narrative discussions of embodiments, do not purport to be completely rigorous treatments of the method, apparatus, and software product under consideration. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various different combinations of hardware and software which need not be further detailed herein. Moreover, although the following claims list particular subject matter of the invention, the list is not exclusive, and additional subject matter is to be found both in the specification and in all possible combinations of the claims regardless of the presently specified dependencies.

What is claimed is:

1. A method comprising:
receiving at the user equipment radio links in parallel from different base stations; and
employing exclusive codes without sharing the exclusive codes with any other user terminal.

2. The method of claim 1,
wherein the method further comprises sharing code of at least one of the radio links with at least one other user terminal, during a soft handover, and
wherein the exclusive codes are employed for a plurality of the radio links other than said at least one of the radio links.

3. The method of claim 1, wherein the the exclusive codes are employed for said radio links.

4. The method of claim 2, wherein only one user terminal is mapped per each of the exclusive codes.

5. The method of claim 2, wherein each of the exclusive codes uses a slot format common to the code of the at least one of the radio links.

6. The method of claim 2, wherein at least one of the radio links drifts during the soft handover, and wherein the method further comprises keeping a drifting radio link within a recever window during the soft handover.

7. The method of claim 3, wherein only one user terminal is mapped per each of the exclusive codes.

8. The method of claim 3, wherein each of the exclusive codes uses the same slot format as for shared radio links.

9. The method of claim 3, wherein the network uses shared codes for terminals not in soft handover to optimize code usage.

10. The method of claim 3, wherein at least one of the radio links drifts during the soft handover, and wherein the method further comprises keeping a drifting radio link within a reciever window during the soft handover.

11. A computer readable medium encoded with a software data structure for performing the method of claim 1.

12. A computer chip configured to perform the method of claim 1.

13. User equipment comprising:
a transceiver configured to receive radio links in parallel from different base stations; and
a drift detection element, responsive to one of the radio links drifting out of a reception window, and configured to request a network adjustment in order to prevent or compensate for the drift;
wherein exclusive codes are arranged to be employed without sharing the exclusive codes with any other user terminal.

14. The user equipment of claim 13,
wherein code of at least one of the radio links is available to be shared with at least one other user terminal, during a soft handover, and
wherein the exclusive codes are arranged to be employed in a plurality of the radio links other than said at least one of the radio links.

15. The user equipment of claim 13, wherein the exclusive codes are arranged to be employed in the radio links.

16. A system comprising:
a plurality of base stations;
user equipment for receiving radio links in parallel from the plurality of base stations during a soft handover; and
other user terminals, for sharing code of at least one of the radio links with the user equipment, during the soft handover;
wherein exclusive codes are employed by the user equipment, said exclusive codes not being shared with the other user terminals.

17. The system of claim 16, wherein the exclusive codes are used for a plurality of the radio links other than said at least one of the radio links.

18. The system of claim 16, wherein the exclusive codes are used for the radio links.

19. A network element comprising:
means for sending to a user equipment a radio link in parallel with other radio links from different base stations or sectors; and
means for employing an exclusive code for the radio link if one of the other radio links employs a shared code that is shared with at least one other user terminal.

20. A network element comprising:
a sender module configured to send to the user equipment a radio link in parallel with other radio links from different base stations or sectors; and
a selector configured to employ an exclusive code for the radio link if one of the other radio links employs a shared code that is shared with at least one other user terminal.

21. A software product for use in user equipment to process downlink codes during soft handover, the software product comprising a computer readable medium having executable codes embedded therein; the executable components, when executed, adapted to carry out the functions of:
receiving at the user equipment radio links in parallel from different base stations or sectors; and
employing exclusive codes for a plurality of the radio links, wherein the exclusive codes are not shared with any other user terminal.

22. The software product of claim 21,
wherein the executable components, when executed, are also adapted to share code of at least one of the radio links with at least one other user terminal, during the soft handover, and
wherein the plurality of the radio links exclude said at least one of the radio links.
